(19) United States
(12) Patent Application Publication
(10) Pub. No.: US 2020/0051022 A1
(43) Pub. Date: Feb. 13, 2020

(54) ELECTRONIC FILE CABINET

(71) Applicants: Kimone James, Elmwood Park, NJ (US); Christopher James, Elmwood Park, NJ (US)

(72) Inventors: Kimone James, Elmwood Park, NJ (US); Christopher James, Elmwood Park, NJ (US)

(21) Appl. No.: 16/101,457

(22) Filed: Aug. 12, 2018

(51) Int. Cl. G06Q 10/10; B02C 18/00

(52) U.S. Cl. CPC G06Q 10/10; A47B 2063/005; A47B 2220/0091; B02C 18/0007

(57) ABSTRACT

An electronic file cabinet, including a main body, an input unit disposed on the main body to receive an input from a user, a plurality of storage units disposed within the main body to store at least one of a paper, a document, and a file folder therein, and a paper receiving slot to receive and introduce into the main body the at least one of the paper, the document, and the file folder, such that the input routes the at least one of the paper, the document, and the file folder into a predetermined one of the plurality of storage units.

### BACKGROUND

### 1. Field

The present general inventive concept relates generally to a file cabinet, and particularly, to an electronic file cabinet.

### 2. Description of the Related Art

Although society has presently been opting for “paperless” communication, companies and individuals must still keep hard copies for a certain number of years for convenience and legal matters. However, sorting through boxes of old paperwork and looking for storage locations to store hundreds of paper files can be inconvenient and time-consuming.

Therefore, there is a need for an electronic filing system that electronically stores and catalogues paper files.

### SUMMARY

The present general inventive concept provides an electronic file cabinet.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic file cabinet, including a main body, an input unit disposed on the main body to receive an input from a user, a plurality of storage units disposed within the main body to store at least one of a paper, a document, and a file folder therein, and a paper receiving slot to receive and introduce into the main body the at least one of the paper, the document, and the file folder, such that the input routes the at least one of the paper, the document, and the file folder into a predetermined one of the plurality of storage units.

The main body may rotate in response to a command input into the input unit.

A paper shredder may be disposed within the main body to shred at least one of the paper, the document, and the file folder, based on the user's preference.

The electronic file cabinet may further include a paper grasping mechanism to grasp the at least one of the paper, the document, and the file folder, and a motor to move the at least one of the paper, the document, and the file folder toward and into the predetermined one of the plurality of storage units.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of an electronic file cabinet, according to an exemplary embodiment of the present general inventive concept.

FIG. 2 illustrates a semi-cross-sectional side perspective view of an electronic file cabinet, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

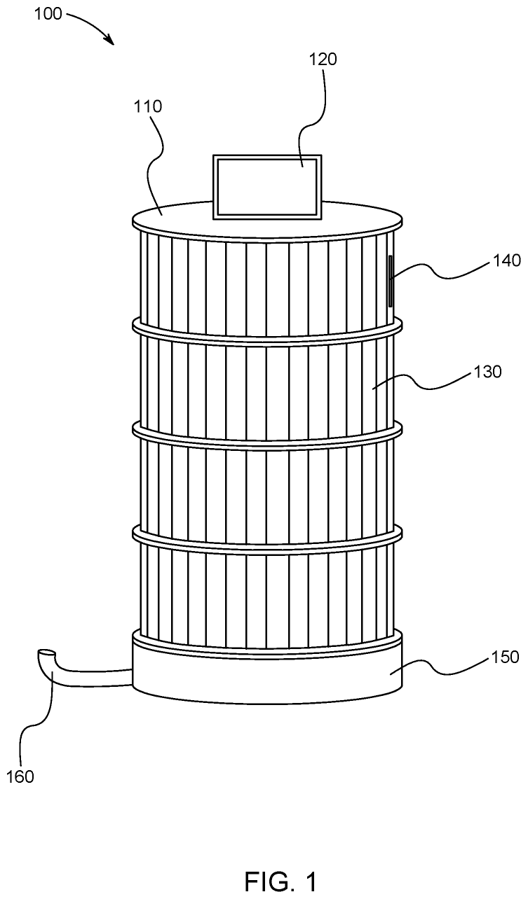

FIG. 1 illustrates a side perspective view of an electronic file cabinet 100, according to an exemplary embodiment of the present general inventive concept.

The electronic file cabinet 100 may include a main body 110, an input unit 120, a plurality of storage units 130, a paper receiving slot 140, a paper shredder 150, and a shredder vacuum 160, but is not limited thereto.

The main body 110 may rotate manually, or may be controlled to rotate via the input unit 120.

The input unit 120 may be a monitor having a screen such as a touch screen, an LCD screen, a plasma screen, a keyboard, etc., but is not limited thereto. The input unit may also be a computer device, a laptop computer, a tablet computer, a mobile device, etc., but is not limited thereto.

The input unit 120 may allow a user to input various commands to control placement of paper and files stored within the electronic file cabinet 100. In other words, the user may input commands using the input unit 120 to label each of the plurality of storage units 130 for categorization and easy location, to schedule a shredding session, to shred paper immediately, to store paper and/or files into particular storage units 130, and to open the plurality of storage units 130 automatically based on the user's selection of the appropriate file on the input unit 120.

The plurality of storage units 130 may include a plurality of slots, compartments, drawers, etc., disposed within the main body 110, which may receive files and/or papers therein.

The plurality of storage units 130 may be electronically connected to the input unit 120, such that a user may type in an instruction into the input unit 120 to allow a paper and/or a file folder inserted into the paper receiving slot 140 to be directed toward and placed within a selected one of the plurality of storage units 130 from an inside of the main body 110. As such, each of the plurality of storage units 130 are customizable and may be precoded and/or encoded via the input unit 120, such that individual storage units 130 are easy to locate.

If a file folder is inserted into the paper receiving slot 140, a barcode on the file folder may be scanned by a scanning unit within the paper receiving slot and/or within the main body 110. Alternatively, the use may input a name (or other identifying information) into the input unit 120, and print out a label including the name and/or barcode from the paper receiving slot 140 (which also optionally may include a label printer), such that the label may be placed on the file folder which is to be inserted into the paper receiving slot 140 to be stored within one of the plurality of storage units 130. As such, individual documents that need to be placed in a particular file folder stored within the particular one of the plurality of storage units 130 may be easily routed by identifying the name and/or barcode associated therewith.

Individual documents can also be scanned if the hardcopy needs to be saved electronically, and may be saved in the input unit 120 or any other computer system of the electronic file cabinet 100.

Additionally, once the document is stored within the storage unit 130, the input unit 120 may display a message stating that a new document was added to the named file folder, and may query for an input of an expiration date as to how long the document needs to remain in the storage unit 130.

The paper shredder 150 may be disposed within the main body 110, preferably at a bottom portion of the main body 110.

The input unit 120 may be used by the user to input a command to shred a particular file immediately, or on a particular day, based on a predetermined schedule.

The shredder vacuum 160 may be connected to the paper shredder 150 to allow the papers to be sucked into the paper shredder 150, and to expel the shredded paper out from the electronic filing cabinet 100.

All of the above components of the electronic file cabinet 100 may communicate with each other via WIFI, RFID, BLUETOOTH, the Internet, an Intranet, or any other type of wireless or wired communication.

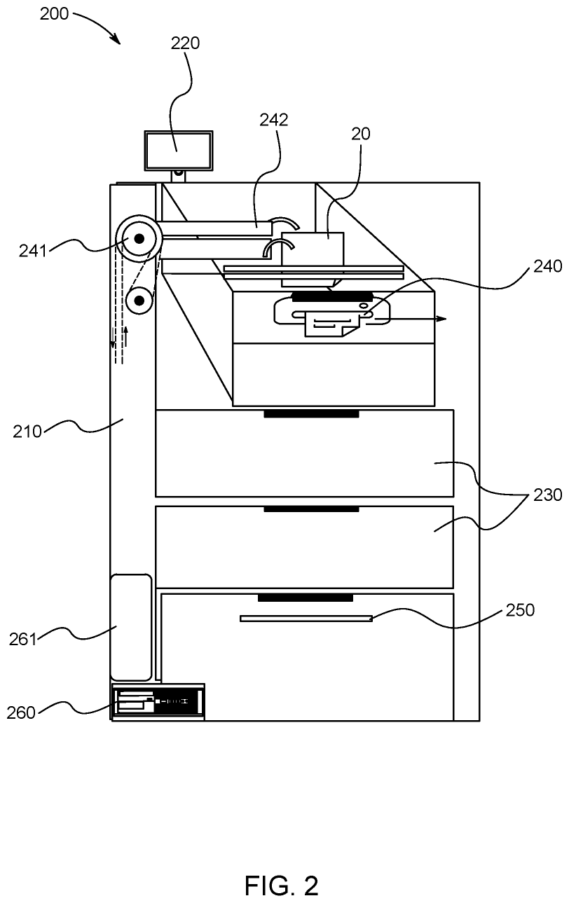

FIG. 2 illustrates a semi-cross-sectional side perspective view of an electronic file cabinet 200, according to another exemplary embodiment of the present general inventive concept.

The electronic file cabinet 200 may include a main body 210, an input unit 220, a plurality of storage units 230, a paper receiving slot 240, a paper shredder 250, and a computer 260, but is not limited thereto.

The main body 210 may rotate manually, or may be controlled to rotate via the input unit 220.

The input unit 220 may be a monitor having a screen such as a touch screen, an LCD screen, a plasma screen, a keyboard, etc., but is not limited thereto. The input unit may also be a computer device, a laptop computer, a tablet computer, a mobile device, etc., but is not limited thereto.

The input unit 220 may allow a user to input various commands to control placement of paper and files stored within the electronic file cabinet 200. In other words, the user may input commands using the input unit 220 to label each of the plurality of storage units 230 for categorization and easy location, to schedule a shredding session, to shred paper immediately, to store paper, document, and/or file folders 20 into particular storage units 230, and to open the plurality of storage units 230 automatically based on the user's selection of the appropriate file on the input unit 220.

The plurality of storage units 230 may include a plurality of slots, compartments, drawers, etc., disposed within the main body 210, which may receive files and/or papers therein.

The plurality of storage units 230 may be electronically connected to the input unit 220, such that a user may type in an instruction into the input unit 220 to allow a paper and/or a file folder inserted into the paper receiving slot 240 to be directed toward and placed within a selected one of the plurality of storage units 230 from an inside of the main body 210. As such, each of the plurality of storage units 230 are customizable and may be precoded and/or encoded via the input unit 220, such that individual storage units 230 are easy to locate.

If a file folder is inserted into the paper receiving slot 240, a barcode on the file folder may be scanned by a scanning unit within the paper receiving slot and/or within the main body 210. Alternatively, the use may input a name (or other identifying information) into the input unit 220, and print out a label including the name and/or barcode from the paper receiving slot 240 (which also optionally may include a label printer), such that the label may be placed on the file folder which is to be inserted into the paper receiving slot 240 to be stored within one of the plurality of storage units 230. As such, individual documents that need to be placed in a particular file folder stored within the particular one of the plurality of storage units 230 may be easily routed by identifying the name and/or barcode associated therewith.

Connected to and in communication with the paper receiving slot 240 may be a motor 241, which may move a paper grasping mechanism 242 to help move the inserted papers, documents, and/or file folders within the main body 210, such that the papers, documents, and/or file folders may be stored at the appropriate storage unit 230.

Individual documents can also be scanned if the hardcopy needs to be saved electronically, and may be saved in the input unit 220 or any other computer system of the electronic file cabinet 200, such as the computer 260.

Additionally, once the document is stored within the storage unit 230, the input unit 220 may display a message stating that a new document was added to the named file folder, and may query for an input of an expiration date as to how long the document needs to remain in the storage unit 230.

The paper shredder 250 may be disposed within the main body 210, preferably at a bottom portion of the main body 210.

The input unit 220 may be used by the user to input a command to shred a particular file immediately, or on a particular day, based on a predetermined schedule.

A remote control 261 may be included to allow communication between the computer 260 and the input unit 220.

All of the above components of the electronic file cabinet 200 may communicate with each other via WIFI, RFID, BLUETOOTH, the Internet, an Intranet, or any other type of wireless or wired communication.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An electronic file cabinet, comprising:
a main body;
an input unit disposed on the main body to receive an input from a user;
a plurality of storage units disposed within the main body to store at least one of a paper, a document, and a file folder therein; and
a paper receiving slot to receive and introduce into the main body the at least one of the paper, the document, and the file folder, such that the input routes the at least one of the paper, the document, and the file folder into a predetermined one of the plurality of storage units.

2. The electronic file cabinet of claim 1, wherein the main body rotates in response to a command input into the input unit.

3. The electronic file cabinet of claim 1, further comprising a paper shredder disposed within the main body to shred at least one of the paper, the document, and the file folder, based on the user's preference.

4. The electronic file cabinet of claim 1, further comprising:
a paper grasping mechanism to grasp the at least one of the paper, the document, and the file folder; and
a motor to move the at least one of the paper, the document, and the file folder toward and into the predetermined one of the plurality of storage units.
